(19) United States
(12) Patent Application Publication
(10) Pub. No.: US 2005/0170699 A1
(43) Pub. Date: Aug. 4, 2005

(54) USB OTG adapter module for debugging USB OTG devices

(76) Inventor: Eric J. Overtoom, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/771,266

(22) Filed: Feb. 3, 2004

(51) Int. Cl. H01R 25/00

(52) U.S. Cl. 439/639

(57) ABSTRACT

An apparatus, architecture and method for enabling the debugging of USB OTG devices under development is provided herein. An adapter module (100) provides the capability to connect to a USB Dual Role Device (DRD) (102) under development, and obtain debugging information related to the USB interfaces, while also presenting a complete USB OTG compatible interface to another attached USB apparatus (106). The adapter module (100) filters data transmitted by DRD (102), and passes data to attached PC (104) in a debugging setup.

### FIELD OF THE INVENTION

The present invention relates generally to the Universal Serial Bus (USB) interface and to USB “On-the-Go” (OTG) devices, and more particularly to a USB adapter module for use in debugging USB OTG devices.

### BACKGROUND OF THE INVENTION

In accordance with the USB OTG specifications, a device may use the USB interface and behave either as a USB host, communicating with other peripheral USB devices, or as a peripheral USB device providing a service or services to a USB host. One example of such a Dual Role Device (DRD), that is, a device that may operate as either a USB host or peripheral USB device, is a cellular telephone.

The USB OTG specification was designed to enable point-to-point connections between two devices and to reduce the USB 2.0 specification host support. Particularly, an OTG DRD is only required to support a single device. Further, the USB OTG specification describes a means for two devices to exchange host functionality, which is required for implementation of certain device use cases.

A problem exists, due to host functionality exchange, for devices that have debugging or data logging capability using the USB interface, for the purpose of aiding software development. For example, a device under development is typically attached to a personal computer (PC) running debugging or data logging software. Because the PC in such a configuration behaves as a USB host, the device under development must be connected and behave as a peripheral USB device. Therefore, the device under development must have a physical USB device connector. The problem is that, because the device under development has only a single physical connection, and must be connected to a PC host during debugging, the device cannot be simultaneously connected to a USB OTG device and therefore cannot be observed and debugged while interacting with a USB OTG device.

Some USB DRDs may have an alternative attachment means, such as an embedded debug port with a physical connector other than a USB physical connector, for connecting to debugging equipage. However, such connections are not always available on a device. It is undesirable to design a DRD to have a specialized debug port, in addition to a USB port, due to cost and product profile considerations. Further, even if a distinct debugging port is available, performance reasons may render the use of the port for USB debugging unviable. For example, if problems occur in a device under development when the device is connected to a second USB device and thus using USB OTG features, it is desirable to use software debugging features of the device under development to observe the USB interface.

Further problematic is that, even if a device under development comprises a separate means to connect to a PC for debugging, the function drivers within the test device are generally designed and written to handle a peripheral type connection. Thus, substantial modifications may be required to the device development support software, such that operation of the test device as a USB OTG host would be supported.

Therefore, a need exists for an apparatus in which a USB Host may be connected between two USB OTG devices such that the USB OTG connection is not interfered with if possible, and further such that the communications between the two USB OTG devices may be monitored.

### BRIEF DESCRIPTION OF THE DRAWINGS

FIG. 1 is a schematic connection diagram for a USB OTG Adapter Module, in accordance with an embodiment of the present invention, illustrating a typical debugging setup.

FIG. 2 is a mechanical drawing illustrating various USB receptacle types in accordance with USB standards.

FIG. 3 is a mechanical drawing illustrating various USB mini-plugs in accordance with USB standards.

FIG. 4 is a block diagrams illustrating various hardware and software components of a USB OTG Dual Role Device under development and a USB OTG Adapter Module, in accordance with an embodiment of the present invention.

FIG. 5 is a modification of the block diagram of FIG. 4, to illustrate the bidirectional flow of data between a USB OTG Dual Role Device under development, and a second USB OTG device, through a USB OTG Adapter Module in accordance with an embodiment of the present invention.

FIG. 6 is a modification of FIG. 4, to illustrate the bidirectional flow of data between a USB OTG Dual Role Device under development, and a USB Host with debugging or data logging capability, through a USB OTG Adapter Module in accordance with an embodiment of the present invention.

FIG. 7 is a block diagram illustrating a basic operation of a USB Adapter Module in accordance with an embodiment of the present invention.

FIG. 8 is a block diagram illustrating basic operation of an Adapter Controller in a USB Adapter Module in accordance with an embodiment of the present invention.

### DETAILED DESCRIPTION OF THE PREFERRED EMBODIMENTS

To address the above-mentioned need, an apparatus, architecture and method for enabling the debugging of a USB OTG device under development by monitoring the device's USB link is provided herein.

In accordance with the present invention, an Adapter Module provides the capability to connect to a USB device under development, and obtain debugging information related to the USB interface, while also presenting a complete USB OTG compatible interface useable by other attachable devices. The Adapter Module filters data transmitted by the attached device under development, and passes the data to an attached PC in a debugging setup. A primary benefit derived from the embodiments of the present invention is that a USB device under development can be debugged with respect to its interaction with other USB OTG devices, without the need for physical or software modifications to the device under development. An adapter driver, which is a minimal software component, is added to and present on the USB device under development to facilitate communications with the Adapter Module.

A first aspect of the present invention is a USB OTG debugging system comprising an adapter driver software module that may be installed on a DRD under development; and an adapter having connections for the DRD, a debugging computer, and another USB OTG apparatus. The adapter driver software module provides a virtual USB OTG interface to the adapter. The adapter provides a USB OTG compatible interface for the USB OTG apparatus, and a debugging interface for the PC.

A second aspect of the present invention is a USB dual role device having a single USB physical connection point and software comprising a debugging module, a USB OTG stack, and an adapter driver module to provide a virtual OTG link.

A third aspect of the present invention is a method of debugging a USB OTG dual role device under development comprising; receiving data from the USB OTG dual role device under development, and determining whether the data is on a debugging virtual interface and if so, routing data to a debugging computer. If the data is not received on the virtual debugging interface, then the adapter module may change configuration by command and route data to a second connected USB OTG device in accordance with the new adapter module configuration. If no command is received, and the data is not over the virtual debugging interface, then the adapter module will route data to the second connected USB OTG device in accordance with the existing adapter module configuration.

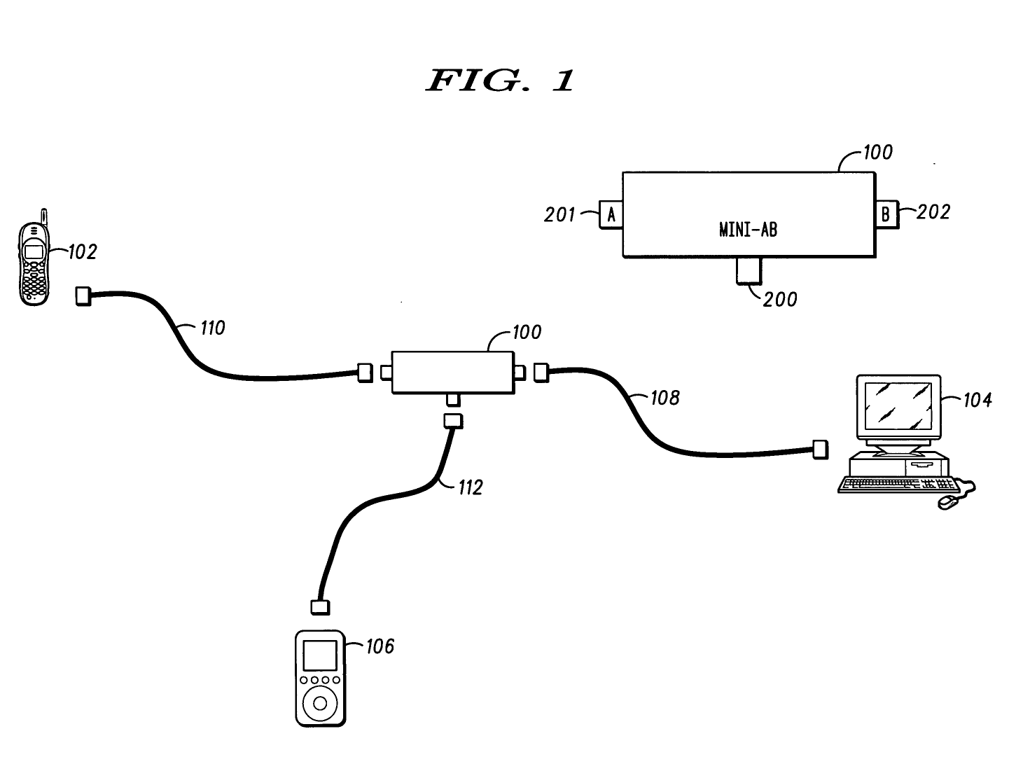

Turning now to the drawings where like numerals designate like components, FIG. 1 is a schematic connection diagram illustrating a typical debugging setup. A USB OTG Adapter Module 100, in accordance with the present invention, is connected to a USB OTG DRD 102 under development via a cable 110. The USB OTG Adapter Module 100 is further connected to a PC 104 via a cable 108, and a second USB OTG device 106, via a cable 112. The cables 108, 110, and 112, have suitable USB connector plugs for each respective device in the setup illustrated by FIG. 1, as well as for the USB OTG Adapter Module 100. Likewise, the USB OTG Adapter Module 100 has suitable USB receptacles; USB Type A receptacle 201, USB Type B receptacle 202, and USB mini-AB type receptacle 200.

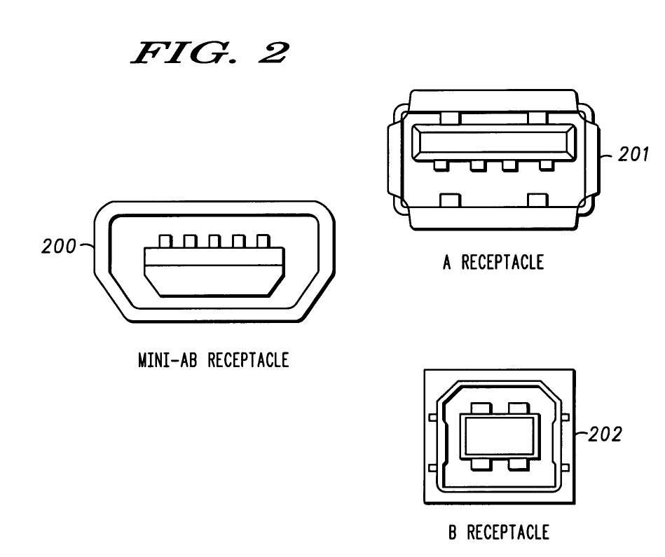

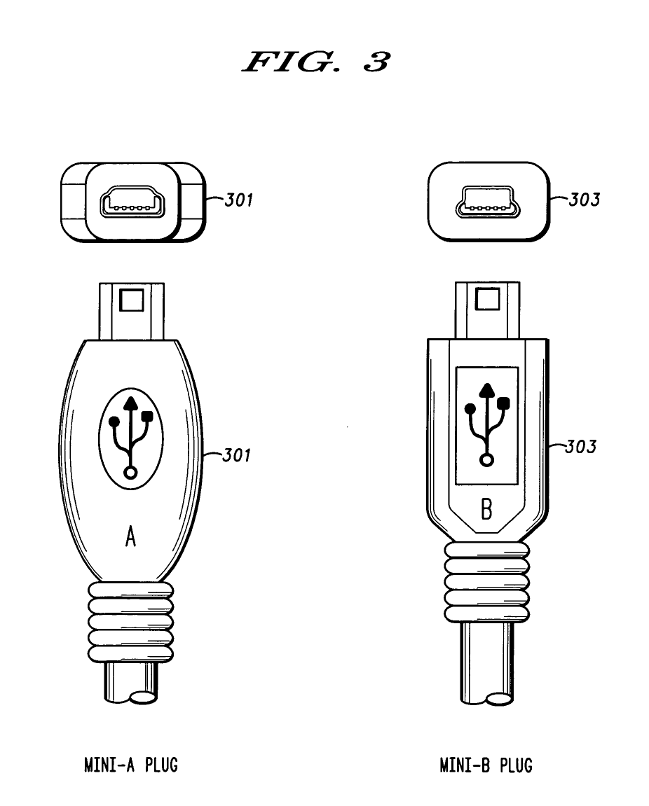

FIG. 2, which is for illustrative purposes only, is a mechanical drawing providing a cross sectional view of each of the connection receptacle types 200, 201 and 202, of the USB OTG Adapter Module 100. FIG. 3, also for illustrative purposes, shows a top and end view of a USB mini-A plug 301 and USB mini-B plug 303, either of which may terminate an end of cable 112 and be connectable to the USB OTG Adapter Module 100 connection 200. The USB specifications define upstream data as data that flows toward a USB host, and downstream data as data that flows away from a USB host. Further in accordance with the definitions of the USB specifications, a downstream port receives upstream data traffic while an upstream port receives downstream data traffic. The mini-AB receptacle 200 can accommodate a mini-A 301 or mini-B 303 plug and can therefore behave as a USB upstream or downstream port, upon initial cable connection, as required by the connected USB OTG device 106, which may be a USB host or a peripheral USB device.

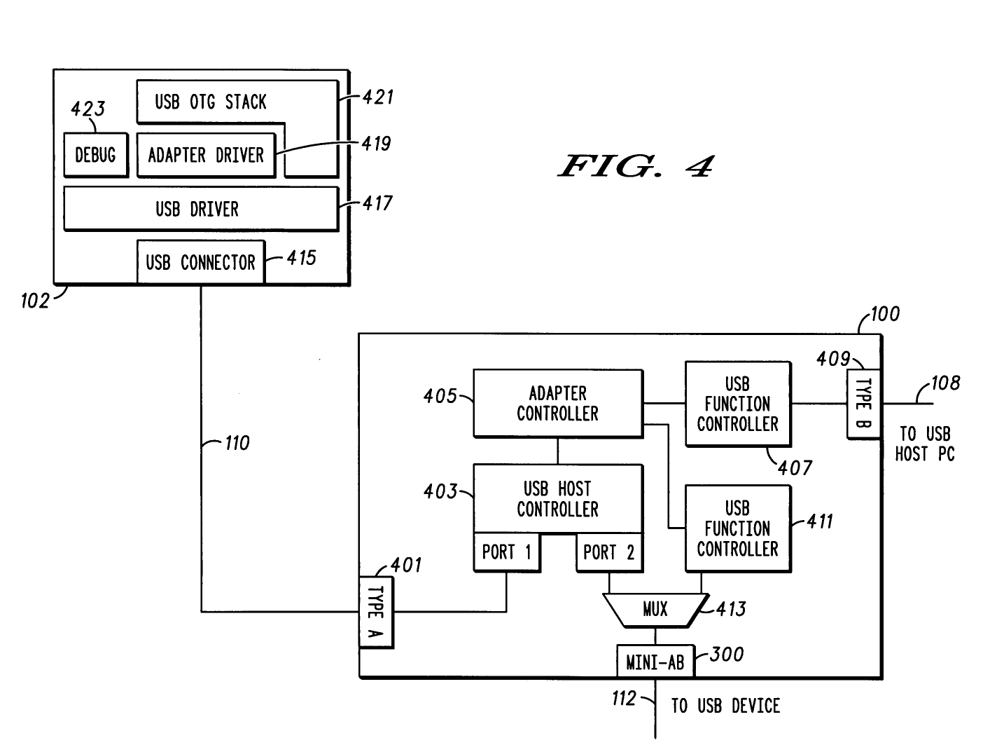

FIG. 4 illustrates the hardware and software components of a USB OTG Adapter Module 100, and also of a USB OTG DRD 102 connected to the Adapter Module 100, in accordance with an embodiment of the present invention. The Adapter Module 100, moves the USB interface logically outside of the DRD 102 during debugging, and allows a separate data stream to be transmitted to a PC host 104. Therefore, two USB interfaces are provided by the Adapter Module 100; a first USB interface in which the DRD 102 behaves as a peripheral device and the Adapter Module 100 behaves as a host, and a second USB interface to provide debugging data routing to the PC 104 for device control.

Returning to FIG. 4, DRD 102 may or may not have hardware support for USB OTG operation. If DRD 102 does not have hardware to support OTG, it may have a type-B 202 or mini-B receptacle as USB Connector 415. Alternatively in the case of no OTG hardware support, DRD 102 may have a connected cable with a type-A or mini-A plug termination. In this case cable 110 may have a fixed connection at connection 415.

Whether or not DRD 102 supports OTG via hardware, it will support OTG via software for operation as a host and as a peripheral device, as is indicated by the USB OTG Stack 421 which is a software component. In FIG. 4, DRD 102 also comprises an adapter driver 419 software component, which generates the particular protocols needed to support the interface over USB cable 110 to Adapter Module 100. In DRDs that do not have OTG hardware support, as described above, but software support only, adapter driver 419 may be necessary for use as an OTG interface.

The DRD 102 USB interface is capable of supporting two virtual interfaces; a first virtual interface for connection to the adapter module 100 control logic, and a second virtual interface to support a debugging stream. If the DRD 102 was to be tested independently of other USB devices, then PC 104 could be connected directly via USB Connector 415, and would use the debugging virtual interface directly. It is to be understood that there may be multiple configurations of the USB interface of DRD 102. Therefore, the particular configuration used for OTG debugging may not be the same as the configuration used for a direct debugging use case, and may also not be the same as when DRD 102 is used as a USB device.

If DRD 102 is operating in a debug environment, and Adapter Module 100 is connected, the USB OTG Stack 421 will operate on top of the adapter driver module 419. The adapter driver module 419 provides the same software interfaces and controls as does the actual USB hardware driver. However, instead of directly interfacing to the hardware, adapter driver module 419 converts the hardware interfaces to a series of command and data packets that are sent to the adapter module 100. The adapter module 100 then uses the command and data packets to drive its internal hardware.

Turning now to the adapter module 100, as illustrated by FIG. 4, the adapter module 100 comprises adapter controller 405, which is the controlling microprocessor, a USB host controller 403 which has two root ports, and two USB function controllers 407 and 411. The function controller 407 is used for the PC 104 debugging interface. The function controller 411 is multiplexed, via multiplexer (“mux”) 413, with one of the host controller 403 root ports, onto a mini-AB receptacle 300. Adapter module 100 provides, via mini-AB receptacle 300, an OTG compatible interface to other USB OTG devices.

In operation of the debugging setup illustrated by FIG. 1, the USB OTG stack 421 of DRD 102 operates normally, with adapter driver module 419 providing a transparent interface to the OTG hardware of adapter module 100. The host controller 403 uses one root port to interface with DRD 102. The command and data packets received by USB host controller 403, at for example root port 1, over the virtual USB interface are used by USB host controller 403 to further send and receive data over the second OTG root port or an OTG function controller for communication with a USB OTG device, for example OTG device 106, connected to adapter module 100 at USB receptacle 300 via USB cable 112.

The command and data packets transmitted and received between DRD 102 and adapter module 100, over the USB virtual interface, correspond directly to interfaces used by OTG stack 421 and are used to control the communication with the attached OTG device, for example OTG device 106.

However, command and data packets that are transmitted and received by USB host controller 403 over the debugging virtual interface are routed to the USB function controller 407 for communication with PC 104. In embodiments of the present invention, the PC 104 generates commands in the same manner as if it were directly attached to DRD 102. The adapter controller 405, which is a hardware component, comprises software code for routing and interpreting commands and data between USB host controller 403 and USB function controller 407 for communication with PC 104.

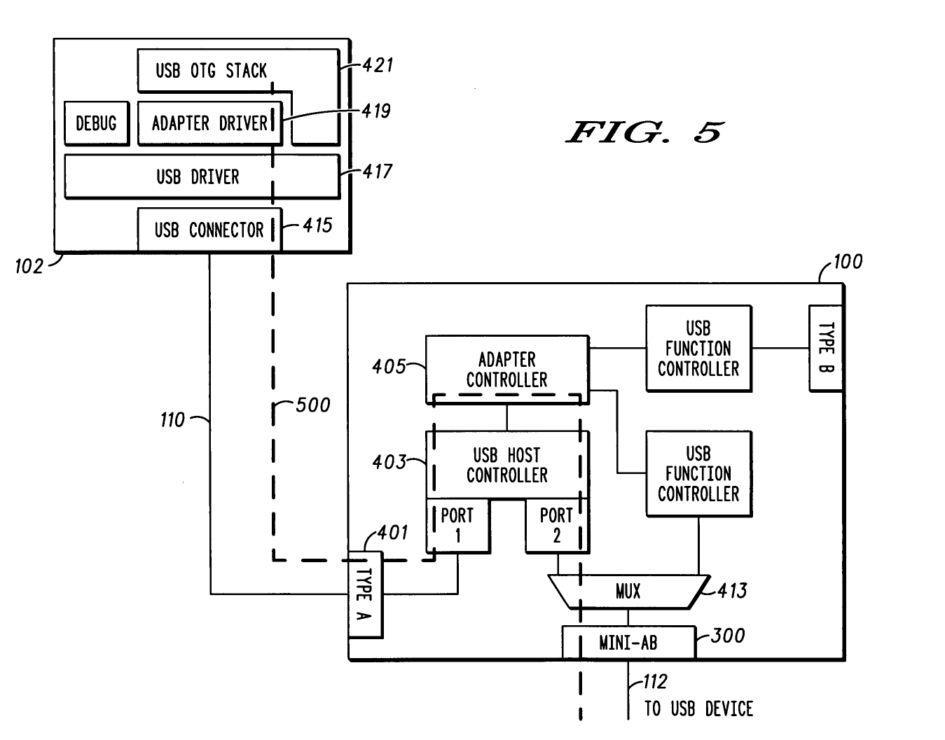

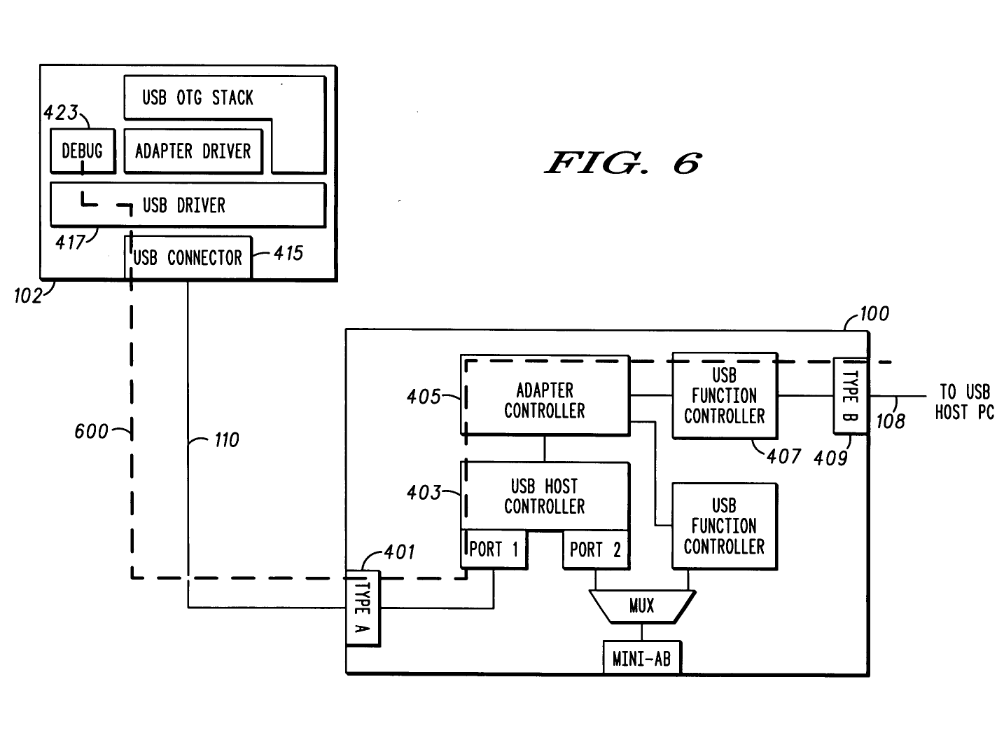

FIGS. 5 and 6 are modifications of FIG. 4 to illustrate the flow of data between the various components of DRD 102 and Adapter Module 100 with respect to attached USB device 106 and PC host 104, respectively. FIG. 5 illustrates the data path 500 between DRD 102 and attached USB device 106, through the Adapter Module 100. Data path 500 comprises the command and data packets that correspond to USB OTG stack 421 interfaces.

Command and data packets are received by Adapter Controller 405 using the USB host controller 403. The Adapter Controller 405 uses commands to configure the operation of the USB mini-AB port 300, connecting either a root port of the USB host controller 403 or the USB function controller 411. When data packets are received to be sent to the attached USB device 106, they are then sent using USB host controller 403 or USB function controller 411, depending on whether the mini-AB port 300 is acting as a USB host or a USB device. Data that is received from the attached USB device 106 is then received by the Adapter controller 405, and routed to DRD 102 where they are moved through the OTG stack 421 to the appropriate software components.

FIG. 6 illustrates the data path 600 between DRD 102 and PC host 104, through the Adapter Module 100. Debugging data packets output from the DRD debugging interface 423 are received in the Adapter Controller 405 over a virtual USB interface separate than the virtual interface that conveys data path 500. The Adapter Controller 405 then places this data into the Function Controller 407 for transmission to the attached PC host 104. Commands from the PC host 104 are received at the Function Controller 407, from which the Adapter Controller 405 transmits them over the USB virtual interface to the debugging software 423 in the DRD 102.

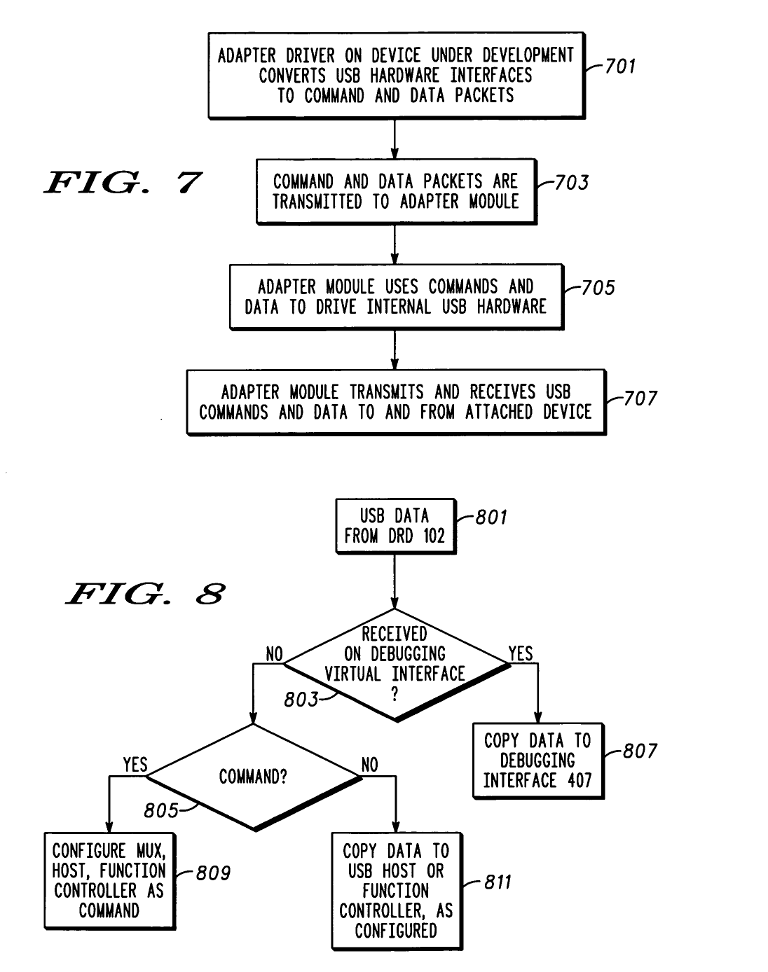

FIG. 7 is a block diagram illustrating in a simplified manner how the adapter module 100 communicates with USB apparatus 106 as a proxy for the software components within the DRD 102. The adapter controller 405 handles all of the OTG protocol operations between the DRD 102 and USB apparatus 106, and also handles the timing related to Host Negotiation Protocol (HNP) in which host control is transferred to one of either the DRD 102 or USB device 106. In block 701, the adapter driver 419 communicates with the USB OTG stack 421 and converts USB hardware interfaces to command and data packets that are transmitted over the virtual link to the adapter 100 in block 703. The adapter module 100 internal hardware is driven by the commands in block 705, and communicates as a proxy with attached device 106 in block 707.

FIG. 8 is a block diagram illustrating the basic functions of the adapter controller 405 in accordance with an embodiment of the present invention. In block 801, the adapter controller 405 receives data, via USB host controller 403. If the data is received on the debugging virtual interface as determined in block 803, then adapter controller 405, in block 807, copies data to USB function controller 407, which is for the debugging interface.

If data is not received on the debugging interface and no command is received in block 805, then data is copied to the USB host controller 403 or function controller using the existing configuration of the adapter module 100. Otherwise, as shown in block 809, the adapter controller 405 will configure the mux 413, host controller 403, and function controllers 407 and 411 as commanded in block 805.

In some embodiments of the present invention, the adapter module 100 may be constructed using separate components for the adapter controller 405, and its associated memory, the USB host controller 403 and the related USB transceivers for each USB port, as well as the function controllers 407 and 411. However, some embodiments may use integrated components that comprise some or all of the necessary components and still remain in accordance with the present invention.

It is to be understood that by using adapter module 100, the DRD 102 software will operate as closely as possible to its normal operation. Even though the DRD 106 OTG link may change from being a USB host to being a peripheral USB device, the USB operation of the links carrying the debug information remain unchanged. Therefore, using the embodiments of the present invention, it is not required to change the DRD 102 debug interfaces.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A universal Serial Bus (USB) on-the-go (OTG) debugging system comprising:
an adapter driver software module installable and executable in a USB OTG device under development to provide a virtual USB OTG interface; and
an adapter comprising:
a first connection point for communicating with said USB OTG device under development using said virtual USB OTG interface and a virtual debugging interface;
a second connection point for communicating with a computer using a debugging interface; and
a third connection point for communicating with a USE apparatus.

2. The debugging system of claim. 1, wherein said adapter further comprises:
a USB host controller coupled to said first connection point;
an adapter controller coupled to said USB host controller;
a first USB function controller coupled to said adapter controller and to said second connection point;
a second USB function controller coupled to said adapter controller; and
a multiplexer coupled to said USB host controller, said second USB function controller, and said third connection point.

3. The debugging system of claim 2, wherein said adapter controller is configured to:
receive command and data packets from said USB host controller and from said first and second USB function controllers;
interpret said command and data packets; and
route said command and data packets to one of said first, second, and third connection points.
